(19) United States
(12) Patent Application Publication
(10) Pub. No.: US 2022/0283059 A1
(43) Pub. Date: Sep. 8, 2022

(54) PORTABLE-DYNAMIC VAPOR MICROEXTRACTION

(71) Applicants: The Regents of the University of Colorado, a body corporate, Denver, CO (US); Government of the United States of America, as represented by the Secretary of Commerce, National In, Gaithersburg, MD (US)

(72) Inventors: Adam J. Friss, Louisville, CO (US); Megan E. Harries, Boulder, CO (US); Tara M. Lovestead, Louisville, CO (US)

(21) Appl. No.: 17/687,155

(22) Filed: Mar. 4, 2022

Related U.S. Application Data
(60) Provisional application No. 63/156,797, filed on Mar. 4, 2021.

(51) Int. Cl. G01N 1/22

(52) U.S. Cl. CPC G01N 1/2273; G01N 1/2214; G01N 2001/2276

(57) ABSTRACT

Portable dynamic vapor micro-extraction systems for use in real-time trace vapor collection in the field. The system includes one or more wafer collection modules or cartridges that include a plurality of sample collection capillaries, each cartridge being receivable into an associated vapor collection device of the system, for collecting a vapor sample in the field. The vapor collection device includes a thermoelectric cooler providing a cold plate directly thermally coupled to an installed cartridge. The thermoelectric cooler provides cooling to a temperature below ambient temperature, while vapor sampling occurs. A pump draws the vapor sample through a sample port of the device, and into the received cartridge, such that target molecules to be detected are adsorbed. The system can further include a cartridge storage compartment, for storing the cartridges.

### CROSS REFERENCE TO RELATED APPLICATION

The present application claims the benefit of U.S. Provisional Patent Application Ser. No. 63/156,797, filed on Mar. 4, 2021, the disclosure of which is herein incorporated by reference in its entirety. Each article or reference cited in the provisional application is also herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce, under cooperative agreement number 70NANB18H006. The Government has certain rights in the invention.

### BACKGROUND

### Technical Field

The present application relates to systems and methods for vapor sampling, e.g., for various forensics, law enforcement, environmental monitoring, and other uses where trace vapor diagnostics would be useful. In particular, the present systems are field deployable, providing dynamic and portable vapor micro-extraction in any given environment.

### Relevant Technology

It is often necessary to obtain vapor samples within the field, for later analysis in the lab. Examples of such sampling include activated carbon personnel monitoring badges, or whole-air canisters or bags. While such existing systems are available and allow for collection of samples, such existing systems exhibit shortcomings. For example, activated carbon monitoring badges can suffer from selective adsorption, and displacement of various target molecules being monitored for, while whole-air canisters or bags can sometimes result in decomposition or other reaction of the sample composition once collected in the canister or bag, even where such container may include a specialized inert coating.

Accordingly, there are a number of problems and disadvantages with existing systems and methods that can be addressed.

### BRIEF SUMMARY

Various embodiments disclosed herein are related to systems and methods for improved sample collection in the field. An example of such a portable dynamic vapor micro-extraction system for use in real-time trace vapor collection in the field may include one or more wafer collection modules (e.g., configured as cartridges, and referred to herein interchangeably as a wafer collection module or cartridge) and a vapor collection device. Each wafer collection module or cartridge can include a plurality of sample collection adsorbent capillaries (e.g., a bundle of adsorbent capillaries). Each wafer collection module or cartridge is selectively receivable (e.g., insertable) within the vapor collection device during use for collection of target molecules from a vapor sample in the field. While the system is described as configured to collect target “molecules”, it will be understood that simpler elements may also be collected. Use of the term “target” is used herein for simplicity, and encompasses such simpler elements, that may not technically be molecules.

The vapor collection device may include a thermoelectric cooler or other mechanism for providing a cold plate surface, where a selected wafer collection module or cartridge can be thermally coupled to the cooled surface provided by the thermoelectric cooler cold plate. Cooling of the wafer collection module or cartridge advantageously increases the efficiency at which target molecules in the vapor sample are captured within the capillaries of the cartridge. By way of example, the thermoelectric cooler may cool the capillaries where capture of target molecules occurs to a temperature that is lower than a typical ambient temperature of the environment in which sample collection is occurring. By way of example, cooling may to at a temperature of from 0° C. to −40° C.

The vapor collection device may include an internal pump configured to draw the vapor sample through a sample inlet probe, and into or through the wafer collection module or cartridge that is inserted into the vapor collection device. As the vapor sample passes through the capillaries of the wafer collection module or cartridge, target molecules to be detected are captured within the capillaries of the module or cartridge. In an embodiment, the sample inlet probe itself may be heated. For example, the inlet probe is heated to a temperature above ambient temperature, while the cartridge (particularly the capillaries thereof) is cooled. Power for the device can be provided through batteries or another portable power source, as portability and true independence of the system is important. For example, battery power may be used to power the thermoelectric cooler and the pump, provide heat to the sample probe, power a user interface of the device, etc.

In an embodiment, the adsorbent capillaries of the wafer collection module or cartridge may be porous layer open tubular (PLOT) capillaries. It will be appreciated that other types of adsorbent capillaries may also be used, e.g., depending on the target molecules the vapor sample of the given environment is being evaluated for. Non-limiting examples of adsorbent capillaries that may be used include, but are not limited to wall coated open tubular (WCOT) capillaries, support coated open tubular (SCOT) capillaries, uncoated capillaries, or other adsorbent capillaries that will be apparent to those of skill in the art in light of the present disclosure.

In an embodiment the pump and overall system may be configured to pull the vapor sample through the system, (rather than pushing it through the system). Such a configuration may minimize contamination or reaction of any target molecules as they are conveyed through the system, into the capillaries of the wafer collection module or cartridge. In an embodiment, the pump is a positive displacement pump (e.g., where energy is added to a fluid by applying force to the liquid with a mechanical device such as a piston or plunger), compressing the fluid mechanically, causing a direct rise in potential energy. An example of a positive displacement pump is a diaphragm pump.

The system can also include a wafer storage compartment configured to pre-chill the wafer collection modules or cartridges before use, as well as chill modules or cartridges that have already been used to collect target molecules from a vapor sample. Such a storage compartment may include a thermoelectric cooler or other mechanism (e.g., dry ice), configured to chill the cartridges, both before installation in the vapor collection device, and after such module or cartridge has been used to collect a sample. Each module or cartridge may include an RFID tag or similar unique identifier. When a module or cartridge is installed in the vapor collection device, the unique identifier can be read and recorded to system memory. By identifying each module or cartridge, various measured system and environmental parameters such as the GPS coordinates for the sample collection, date and time of sample collection, temperature of the cartridge at time of collection, ambient temperature at the field site where the sample was obtained, humidity, vapor sample flow rate, relevant user data, etc., can be retained relative to the module or cartridge. The vapor collection device may itself include an RFID reader (e.g., integrated into the door that closes over the chamber into which the cartridge is receivable), to read the RFID tag of a given installed cartridge.

Such identifying tags may also prevent a user from attempting to collect a sample with a cartridge which already contains a sample (e.g., ruining the original sample). For example, because each cartridge includes an RFID or similar identifying tag, and the vapor collection device includes an RFID reader built in, when a cartridge is installed into the device, the system reads the tag number and can log it. This saves the user from having to write down details relative to the sample, e.g., “sampled cartridge A @ 0:00 am, T=25° C., etc.”, as the system simply makes a digital record of these details. The digital record can be used to provide convenient collection of relevant sample collection data, as well as prevent unintentional resampling of a cartridge. For example, if a given module or cartridge that already contains a sample is installed, the vapor collection device will read the identifier associated with that module or cartridge, and will notify the instrument user of such. In addition, the system may be configured to automatically prevent the pump from starting, to preserve and prevent contamination of the sample already collected in the module or cartridge. Additionally, the ability to track the cartridge throughout a study enables chain of custody tracking and quality assurance/quality control of workflow.

The modules or cartridges are intended for reuse, e.g., after the target molecules in the capillaries have been eluted, e.g., solvent is flushed through the capillaries to extract the adsorbed target molecules from the vapor sample. In an embodiment, the sample can be eluted using thermal desorption. In other words, the cartridge can be heated, causing the adsorbed species to be released. Such elution may be performed in the lab, once the modules or cartridges and vapor collection device are brought back from the field. At such point, the module or cartridge may again be “empty”, and can be reused again. The RFID tag associated with the module or cartridge can be erased from or updated in system memory at this point, so that the system recognizes that this module or cartridge is again ready to obtain a new sample. For example, the digital log may be updated to reflect that wafer “X” was eluted by “NAME” on “DATE” at “TIME” and is now ready for resampling. An individual module or cartridge may be suitable for use tens of times, or even hundreds of times (e.g., 10-1000, or 10 to 500, or 10 to 100 sample collection uses). Data may be kept relative to pressure drop across the capillaries or other relevant parameter, providing an indication to the user as to when an individual module or cartridge needs maintenance, or replacement (e.g., when the pressure drop across the module or cartridge exceeds a baseline, or the flowrate through the wafer or cartridge falls below a given threshold). For example, an unusually large pressure drop may indicate a blockage within one or more of the capillaries of a given cartridge.

The module or cartridge may be fabricated from a suitable substrate material. In an embodiment, it may be formed from a polymer, e.g., such as a thermoset polymer (e.g., pourable during manufacture), an epoxy (e.g., an epoxy or other polymer that has significant thermal conductivity), or other suitable polymer material with the bundle of capillaries integrated into or on the polymer or other substrate layer. Various polymers, including various thermoplastic resins, thermoset resins, epoxies, or other materials that will be suitable will be apparent to those of skill in the art, in light of the present disclosure. The capillaries of the cartridge may be encased or otherwise protected within the substrate of the cartridge. The cartridge may also include a heat transfer plate for contact with the cold plate of the thermoelectric cooler of the vapor collection device, when the cartridge is installed into the vapor collection device, to maintain the cartridge (particularly the capillaries thereof) at a desired chilled temperature. A thermistor may be provided on the cartridge, to ensure that sample flow does not occur until a desired threshold chilled temperature has been reached. Associated thermistor contacts can be provided in the vapor collection device (e.g., in the door) which provide automatic contact with the thermistor of the cartridge, once the door is closed and latched over the cartridge.

Because the cartridge may be stored in a chilled storage compartment before use, this may shorten the time required for the cartridge to reach the predetermined threshold temperature (through conduction of any undesired heat through the heat transfer plate of the cartridge, and the cold plate of the thermoelectric cooler) before sample collection can occur.

As noted, each capillary may be uncoated or can be coated with an appropriate adsorbent stationary phase, selected for the particular target molecules to be collected for a given vapor sampling project. Non-limiting examples of such adsorbent stationary phase materials include alumina (e.g., Al₂O₃), carbon, polymer adsorbent coatings, and the like. Numerous suitable adsorbent coatings that can be used (e.g., such as those used in PLOT, WCOT, or SCOT capillaries) will be apparent to those of skill in the art, in light of the present disclosure.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIG. 1 shows an isometric view of an exemplary portable dynamic vapor collection device of a portable dynamic vapor micro-extraction system according to the present disclosure.

FIG. 2 shows another isometric view of the vapor collection device of FIG. 1.

FIGS. 3-6 show top, side and bottom views respectively, of the vapor collection device of FIG. 1.

FIG. 7 shows an isometric view of the vapor collection device of FIG. 1, with the door exploded away, and a wafer collection module or cartridge ready for insertion.

FIG. 8 shows the vapor collection device with the wafer collection module or cartridge inserted.

FIG. 9 shows an exemplary wafer collection module or cartridge for use with the vapor collection device, for collecting a vapor sample.

FIG. 10 shows the wafer collection module or cartridge of FIG. 9, in an exploded view configuration.

FIGS. 11-12 show a wafer collection module or cartridge storage compartment for chilling modules or cartridges before and after sample collection.

FIG. 13 shows a wafer collection module or cartridge storage compartment, with the thermoelectric cooler shown exploded, and several wafers or cartridges shown for receipt therein.

FIG. 14 is a partial cut-away view into the wafer collection module or cartridge storage compartment.

FIG. 15 illustrates an exemplary portable dynamic vapor micro-extraction system including the vapor collection device and the module or cartridge storage compartment.

FIG. 16 schematically illustrates function of the vapor collection device.

### DETAILED DESCRIPTION OF THE PREFERRED EMBODIMENTS

### Introduction

The present invention is directed to portable dynamic vapor micro-extraction systems for use in real-time trace vapor collection in the field. Such a system may include one or more wafer collection modules or cartridges that include a plurality of sample collection capillaries, each of the wafer collection modules or cartridges being receivable into an associated vapor collection device during use for collecting a vapor sample in the field. The system includes the vapor collection device which can include a thermoelectric cooler or other cooling mechanism providing a cold plate thermally coupled to a selected wafer collection module or cartridge received in the vapor collection device during use. The thermoelectric cooler or other cooling mechanism provides cooling to the received wafer collection module or cartridge to a temperature below ambient temperature, while vapor sampling occurs.

The vapor collection device includes a pump configured to draw the vapor sample through the wafer collection module or cartridge received within the vapor collection device, such that target molecules to be detected are captured within the capillaries of the wafer collection module or cartridge installed in the vapor collection device. The device further includes a sample probe through which the vapor sample is pulled into the vapor collection device, to the wafer collection module or cartridge received within the device. Various other components (e.g., one or more microcontrollers, battery or other power source, memory, mass flow meter, GPS, temperature, pressure and humidity sensors) may also be present, to perform various functions as described herein.

### II. Exemplary Systems and Devices

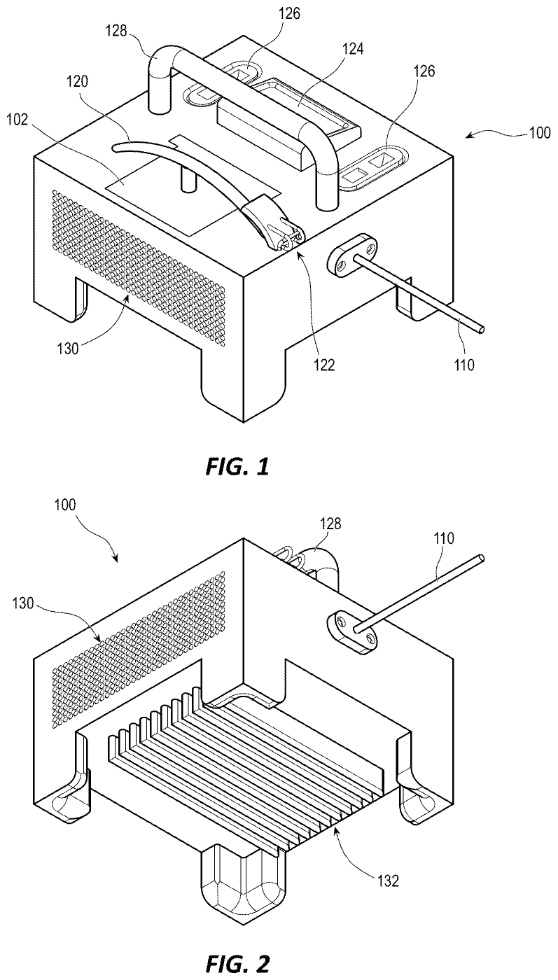

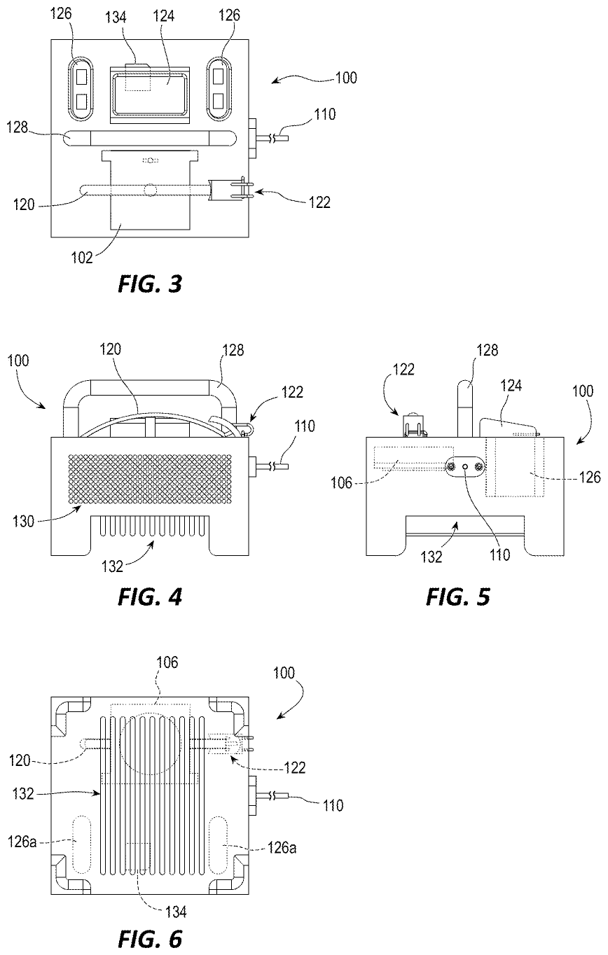

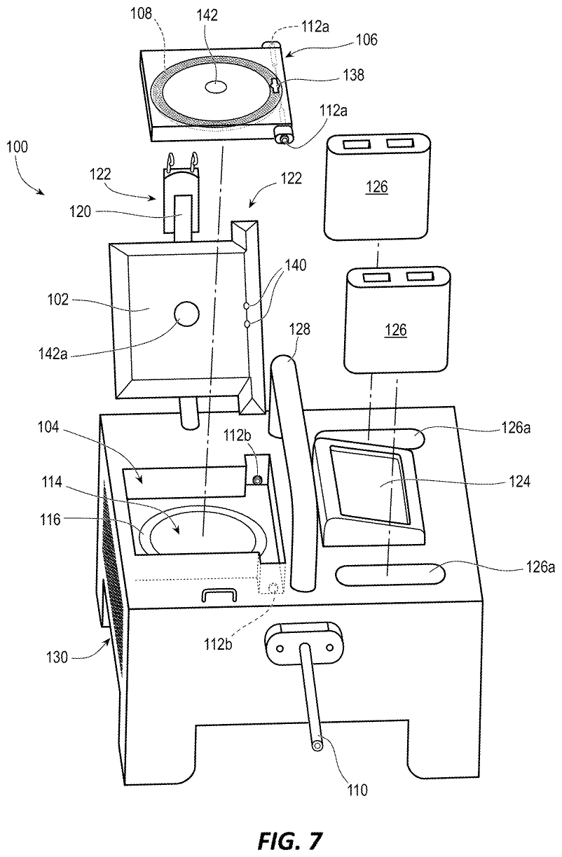

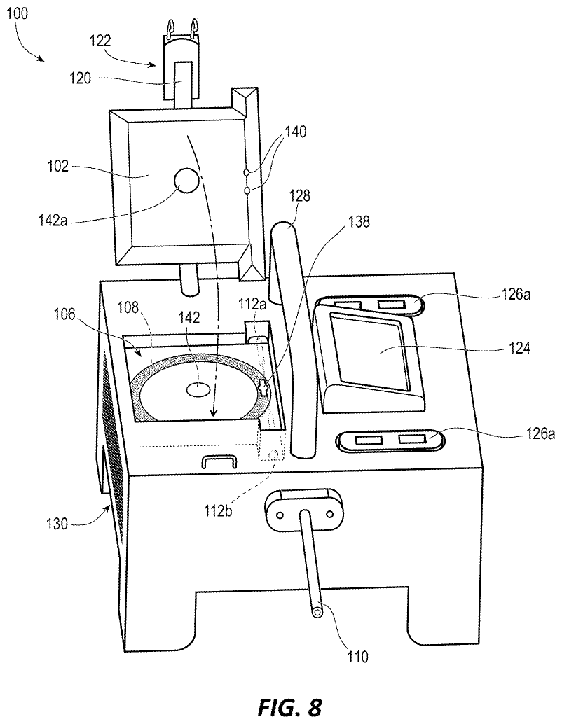

FIGS. 1-8 illustrate an exemplary vapor collection device 100 that can be included in the present portable dynamic vapor micro-extraction system. Device 100 is shown as including a door 102 which when opened (see FIG. 7) provides access into a wafer collection module or cartridge receipt chamber 104, into which a wafer collection module or cartridge 106 can be received. When received into chamber 104, the capillaries 108 of wafer collection module or cartridge 106 can be in fluid communication with sample probe 110 through appropriate flow connection ports (e.g., ports 112a on cartridge 106, and corresponding ports 112b within device 100 (e.g., in chamber 104). For example, flow connection port 112a of wafer collection module 106 can be coupled to a corresponding flow connection port 112b of device 100, that provides fluid connection to sample probe 110, allowing a sample vapor to be pulled through sample probe 110, through the flow connection port interface (e.g., 112a, 112b) and into the capillaries 108 of wafer collection module or cartridge 106. Flow connection ports on the outlet side of the cartridge 106 may similarly allow the remainder of the vapor sample (that portion not adsorbed) to flow out of cartridge 106 through outlet port 112a, and out corresponding port 112b of device 100 (e.g., in chamber 104), for exhausting the remainder of the vapor sample out of device 100.

As perhaps best seen in FIG. 7, beneath chamber 104, may be provided a thermoelectric cooler 114 or other cooling mechanism that provides a cold plate 116 for thermally conductive contact with the wafer collection module or cartridge 106, so as to actively cool the installed wafer collection module or cartridge 106 to a temperature below the ambient temperature in the environment where the vapor sample is being collected. By way of example, the environment where sample collection occurs may typically be from greater than 0° C. to 35° C., although the collection environment could of course potentially be warmer or colder, depending on weather conditions, whether the environment is indoors or outdoors, etc. Door 102 and the surrounding structure defining chamber 104 may be formed from a thermally insulative material, to better maintain the chilled configuration of cartridge 106 when received in chamber 104.

By way of example, in an embodiment, the cold plate and/or thermoelectric cooler 114 may cool the capillaries of the wafer collection module or cartridge 106 to a temperature that is 0° C. or colder (e.g., from 0° C. to −40° C.). It is important to maintain the temperature of the wafer collection module or cartridge 106 (and particularly the capillaries 108 where the sample is captured and stored) to a relatively cold temperature, independent of the temperature of the ambient environment where collection occurs, so as to improve functionality and accuracy of the overall system and device.

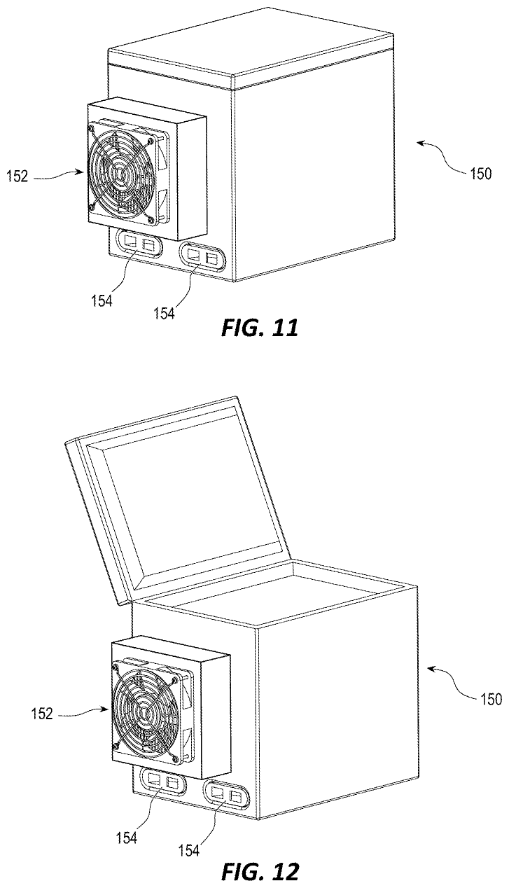

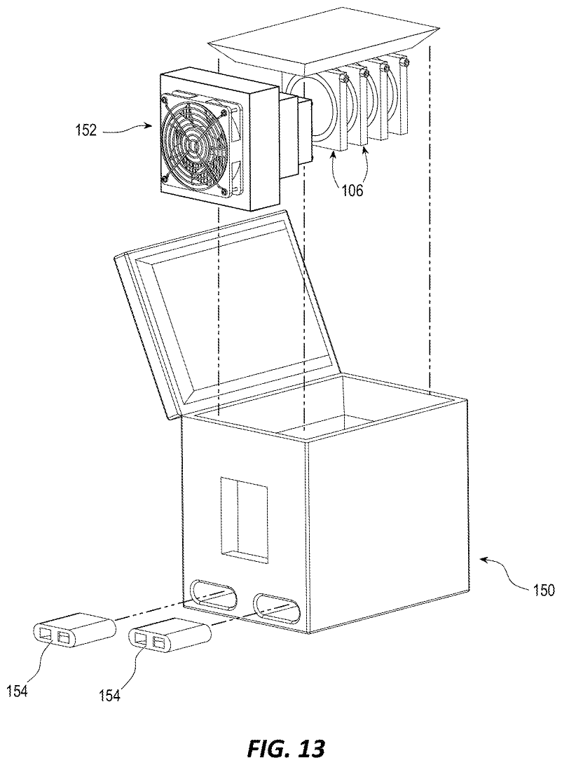

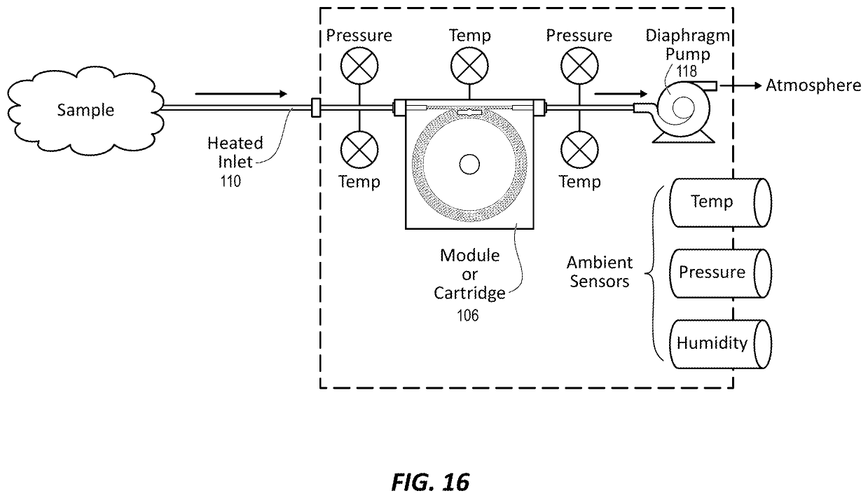

Device 100 further includes a pump 118 (see FIG. 16) configured to draw the vapor sample through the sample probe 110, and through wafer collection module or cartridge 106, e.g., allowing target molecules within the vapor sample to be captured within the capillaries 108 of module or cartridge 106. The remainder of the vapor sample can simply be exhausted, e.g., through the outlet flow connection ports 112a, 112b, and out of device 100. Once a desired quantity of the desired vapor sample has been captured within capillaries 108 of module or cartridge 106, the module or cartridge 106 can be removed from device 100, for storage in an associated storage compartment 150, as will be described in conjunction with FIGS. 11-14, hereafter.

As perhaps best shown in FIGS. 1 and 7-8, device 100 may further include a handle 120 and latch 122 associated with door 102 to secure door 102 over chamber 104. Various other components may also be provided with device 100, such as a user interface 124 (e.g., a GUI), one or more batteries 126 and associated battery compartments 126a, handle 128 (as device 100 is truly portable, and independent, not requiring physical connection to any other device (e.g., for compressed air, power, etc.). Such true portability is in contrast to earlier iterations of similar devices developed at NIST. Air ports 130 for air circulation, heat exchanger fins 132 (e.g., for use by internal thermoelectric cooler 114) and various other components may be present, as will be appreciated by those of skill in the art. In an embodiment, flash memory or similar memory card 134 may be provided, for storing data relative to use of the various cartridges 106 and device 100. In another embodiment, such data could be wirelessly or otherwise transmitted to the lab, or other desired location.

In an embodiment, the pump 118 within device 100 may be configured as a positive displacement pump (e.g., where energy is added to a fluid by applying force to the liquid with a mechanical device such as a piston or plunger), compressing the fluid mechanically, causing a direct rise in potential energy. An example of a positive displacement pump is a diaphragm pump, as schematically shown in FIG. 16. A variety of suitable pump configurations will be apparent to those of skill in the art, in light of the present disclosure.

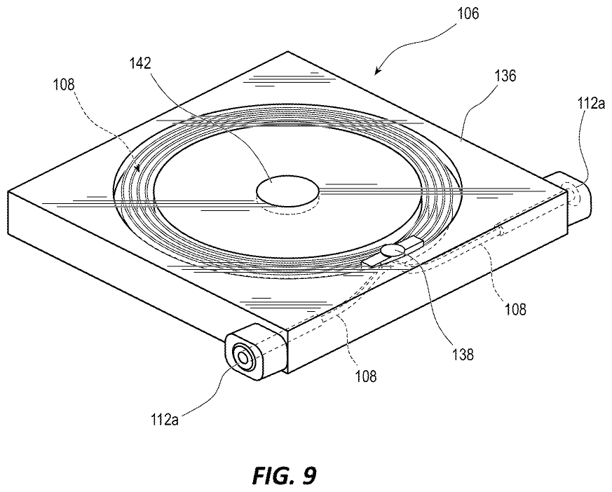

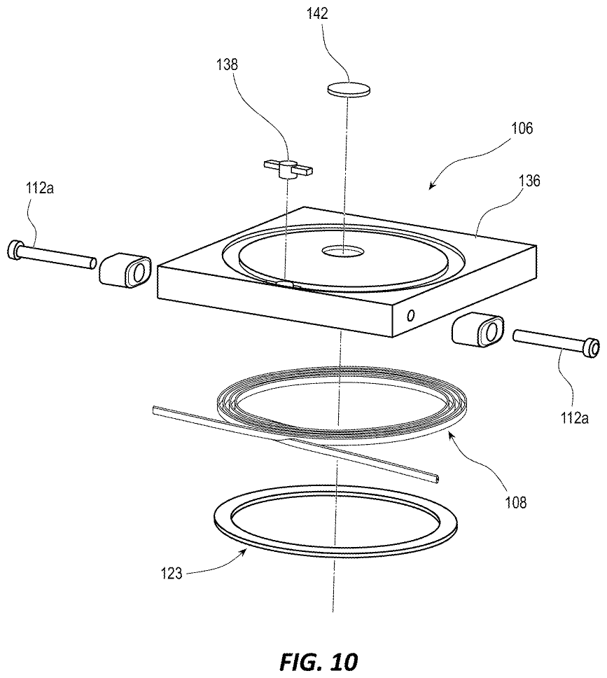

FIGS. 9-10 illustrate various features of wafer collection module or cartridge 106 in greater detail. For example, such a module or cartridge 106 may be configured as a bundle of adsorbent capillaries 108 fixed in a thermoset, epoxy, or other polymer or appropriate substrate 136, where both inlet and outlet flow port connections are provided at 112a for introduction (and exit) of a vapor sample into capillaries 108, through flow ports 112a. In an embodiment, such a bundle may include any desired number of capillaries. For example, such a bundle may include at least 2, at least 3, at least 4 or at least 5 capillaries, such as from 2 to 10, or from 3 to 8 capillaries. For example, a vapor sample is able to flow through sample probe 110 of device 100, through an associated inlet flow port 112b of device 100 (at the proximal end of sample probe 110, e.g., positioned in chamber 104), into the corresponding inlet flow port 112a of module or cartridge 106, and into capillaries 108. Any target molecules to be adsorbed present within the vapor sample are captured within capillaries 108, while the remainder of the vapor sample passes through the outlet flow port 112a of cartridge 106, through corresponding outlet flow port 112b of device 100 (e.g., located in chamber 104 opposite inlet flow port 112b), and out of device 100.

Module or cartridge 106 may further include a thermistor 138 for coupling or contact with a thermistor contact 140 of device 100 (e.g., on the underside of door 102). When the system recognizes via the thermistor that the desired chilled threshold temperature has been achieved and the cartridge 106 is properly received into chamber 104 of device 100, against cold plate 116, the device may allow flow of the vapor sample into and through module or cartridge 106. The thermistor may serve to confirm that the chilled desired threshold temperature has been achieved, so that the pump can then pull the vapor sample into sample probe 110, through the installed module or cartridge 106. Thermistor 138 may thus serve a purpose of ensuring that vapor samples can only be collected when the system is properly chilled.

Module or cartridge 106 may further include an RFID or similar unique identifying tag 142. When a module or cartridge 106 is installed in the chamber 104 of vapor collection device 100, the tag 142 can be read and recorded to system memory (e.g., to memory 134). For example, an RFID reader 142a can be provided in device 100, such as within door 102 (e.g., on an underside of door 102, to read RFID tag 142 when the door is closed). It will be appreciated that other placements of the RFID tag of cartridge 106 and RFID reader 142a are of course also possible, as will be apparent to those of skill in the art, in light of the present disclosure. By identifying each module or cartridge 106, various measured system and environmental parameters such as the GPS coordinates for the sample collection, date and time, temperature of the module or cartridge 106 at time of collection, ambient temperature at the field site where the sample was obtained, humidity, vapor sample flow rate, relevant user data, etc., can be retained relative to the module or cartridge 106, and the sample stored thereon. For example, such metadata can be stored on memory 134.

The adsorbent capillaries 108 of the wafer collection module or cartridge 106 may be any of a variety of adsorbent capillaries, including, but not limited to porous layer open tubular (PLOT) capillaries, wall coated open tubular (WCOT) capillaries, support coated open tubular (SCOT) capillaries, uncoated capillaries, or other adsorbent capillaries that will be apparent to those of skill in the art in light of the present disclosure. Each capillary can be coated with an appropriate adsorbent stationary phase, tailored to the particular target molecules to be adsorbed for a given vapor sampling project. Non-limiting examples of such adsorbent stationary phase materials include alumina (e.g., Al₂O₃), carbon, polymer adsorbent coatings, and the like. Numerous suitable adsorbent coatings will be apparent to those of skill in the art, in light of the present disclosure.

The modules or cartridges 106 are reusable, e.g., after the target molecules in the capillaries have been eluted (e.g., solvent is flushed through the capillaries to extract the adsorbed target molecules). Such elution may be performed in the lab, once the modules or cartridges 106 and vapor collection device 100 are brought back from the field. At such point, the module or cartridge 106 may again be “empty”, and can be reused again. The metadata associated with RFID tag 142 associated with such an emptied module or cartridge 106 can be erased or updated at this point, so that the device 100 recognizes that this empty module or cartridge 106 is again ready to obtain a new sample, when inserted into the device 100. An individual module or cartridge 106 may be suitable for use tens of times, or even hundreds of times (e.g., 10-1000, or 10 to 500, or 10 to 100 sample collection uses). Data may be kept relative to pressure drop across the capillaries or other relevant parameter, providing an indication to the user as to when an individual module or cartridge 106 needs maintenance, or replacement (e.g., when the pressure drop across the module or cartridge exceeds a baseline, or the flowrate through the wafer or cartridge falls below a given threshold). For example, an unusually large pressure drop may indicate a blockage within one or more of the capillaries of a given cartridge 106.

Module or cartridge 106 may include a heat transfer plate 123 (e.g., on an underside of the cartridge 106), to provide direct thermal conduction contact with the cold plate 116 of the thermoelectric cooler 114 of device 100. Such a heat transfer plate may improve heat transfer out of the cartridge, pulling any excess heat out of the cartridge 106, to quickly allow it to reach the threshold chilled temperature (e.g., between 0° C. and −40° C.) so that sample collection can begin. Clamping force provided by clamp 122 may similarly serve to minimize thermal contact resistance between the cartridge 106 and the cold plate 116 of the thermoelectric cooler, when cartridge 106 is installed, and door 102 is clamped shut.

Each flow port 112a, 112b interface may include an o-ring between the flow ports 112a, 112b, where the o-ring is compressed between the ports 112a, 112b when cartridge 106 is inserted and door 102 is closed, providing a gas-tight seal between such ports. The device may be configured so that closing door 102 engages the port connections (between ports 112a of cartridge 106 and ports 112b in chamber 104). The flow port connection mechanism may not include any threaded connections, and may not require handling of the sealing surfaces.

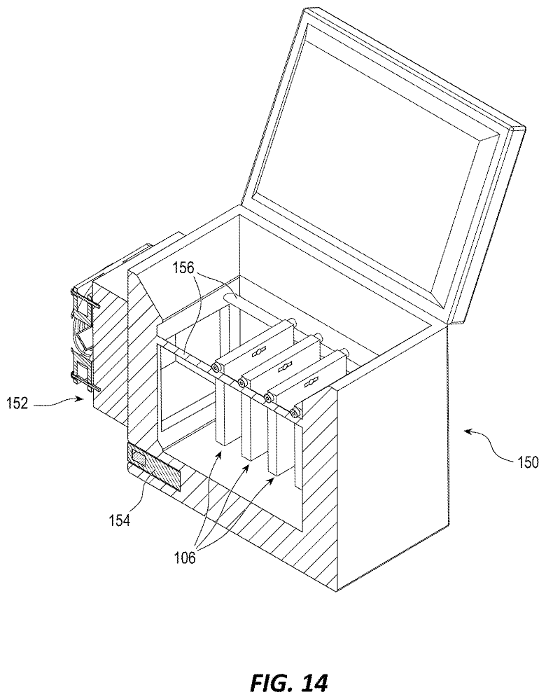

FIGS. 11-14 illustrate a wafer collection module or cartridge storage compartment 150 for use with the vapor collection device 100, which forms part of the overall system for trace vapor collection in the field. Storage compartment 150 is configured to pre-chill modules or cartridges 106 before use, as well as to chill modules or cartridges 106 after they have been used to collect a sample within the device 100. Storage compartment 150 thus serves to reduce thermal equilibration time needed before a cartridge inserted into device 100 reaches the predetermined threshold chilled temperature at which sample collection may begin, and reduces energy requirements for the sample collection device 100. Furthermore, storage of cartridges 106 that have already been used to capture a sample are stored at a chilled temperature (e.g., the same 0° C. to −40° C. range at which sample collection occurs), helping to maintain sample integrity. Storage compartment 150 is shown as including its own thermoelectric cooler 152 for providing a similar cold environment within compartment 150 (e.g., 0° C. to −40° C.), as well as one or more associated batteries 154 for powering the thermoelectric cooler 152. Cooling could additionally or alternatively be provided with dry ice, or the like. One or more rails 156 (FIG. 14) may be provided within storage compartment 150 on which the modules or cartridges 106 may be supported (e.g., similar to hanging file folders in a filing cabinet). It will be appreciated that various other mechanisms could alternatively be used for suspending or otherwise supporting modules or cartridges 106 within the storage compartment 150.

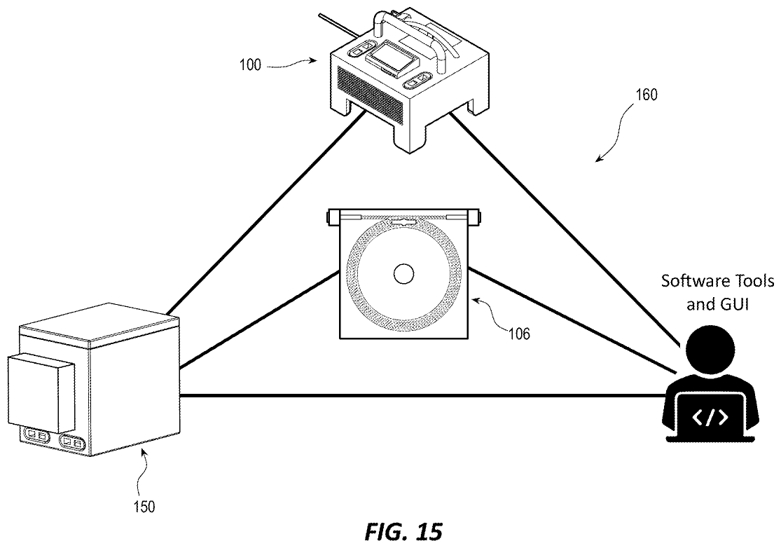

FIG. 15 illustrates an overall system 160, including vapor collection device 100, the storage compartment 150, and cartridge 106, which can be used by the user (in combination with the user interface 124 of device 100 and associated software tools, that allow for collection, tracking, and analysis of data associated with samples collected using system 160, as described herein.

It will be apparent that a wide variety of analysis may be carried out on adsorbed samples, including but not limited to GC-MS, HPLC, NMR, and the like.

Device 100 may function, with various components, such as the sample inlet (e.g., sample probe 110), thermoelectric cooler 114, a mass flow meter, a pump 118, such as a diaphragm pump or other positive displacement pump, which can be operatively connected to a microcontroller and memory (e.g., memory 134). Power to the device 100 can be provided through a battery pack (e.g., batteries 126). A GPS unit may be provided, to provide GPS coordinates for where a given sample on a given module or cartridge 106 was collected.

FIG. 16 schematically illustrates how the sample can be pulled through sample probe 110 (e.g., which may be a heated inlet), and the sample is pulled into the device 100, where pressure and/or temperature conditions can be monitored or recorded at various points, e.g., where the sample is introduced into wafer module or cartridge 106 (which can be maintained at a desired monitored or recorded temperature). The remainder of the sample (other than adsorbed target molecules) exits the cartridge 106 through the outlet connection ports (e.g., 112a and 112b), where temperature and/or pressure may be measured again, and the sample is discharged from device 100 by the pump 118. Any target molecules to be captured within module or cartridge 106 are captured in capillaries 108, while the remainder of the sample (e.g., the nitrogen and oxygen in air, or any other extraneous components present where the sample was taken) is discharged. FIG. 16 also schematically illustrates how the device can be provided with ambient condition sensors, for measuring (and subsequent recording) ambient temperature, pressure, humidity, or the like.

Unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used herein, the term “between” includes any referenced endpoints. For example, “between 2 and 10” includes both 2 and 10.

As used in this specification and the appended claims, the singular forms “a,” “an” and “the” include plural referents unless the content clearly dictates otherwise.

Some ranges may be disclosed herein. Additional ranges may be defined between any values disclosed herein as being exemplary of a particular parameter. All such ranges are contemplated and within the scope of the present disclosure.

1. A portable dynamic vapor micro-extraction system for use in real-time trace vapor collection in the field, the system comprising:
one or more wafer collection modules or cartridges including a plurality of sample collection capillaries, each of the one or more wafer collection modules or cartridges being receivable within an associated vapor collection device during use, for collecting a vapor sample in the field; and
a vapor collection device comprising:
a thermoelectric cooler or other cooling mechanism providing a cold plate thermally coupled to a selected wafer collection module or cartridge received in the vapor collection device during use, the thermoelectric cooler or other cooling mechanism providing cooling to the received wafer collection module or cartridge, to a temperature below ambient temperature;
a pump configured to draw the vapor sample through the wafer collection module or cartridge received within the vapor collection device, such that target molecules to be detected are captured within the capillaries of the wafer collection module or cartridge installed in the vapor collection device; and
a sample probe through which the vapor sample is pulled into the vapor collection device, to the wafer collection module or cartridge received within the vapor collection device.

2. A system as in claim 1, wherein the plurality of capillaries comprises a bundle of capillaries.

3. A system as in claim 1, wherein the capillaries of the wafer collection modules or cartridges comprise porous layer open tubular (PLOT) capillaries or another type of adsorbent capillaries.

4. A system as in claim 1, wherein each capillary is uncoated, or is coated with an adsorbent stationary phase.

5. A system as in claim 4, wherein the adsorbent stationary phase is particularly configured to adsorb the target molecule.

6. A system as in claim 1, wherein the pump is a positive displacement pump.

7. A system as in claim 6, wherein the pump is a diaphragm pump.

8. A system as in claim 1, wherein the system further comprises a wafer collection module or cartridge storage compartment configured to pre-chill the wafer collection modules or cartridges before use, and chill wafer collection modules or cartridges that have been already used to collect target molecules within the vapor collection device.

9. A system as in claim 8, wherein the wafer collection module or cartridge storage compartment comprises one or more rails on which the wafer collection modules or cartridges are supported or suspended, within the storage compartment before or after such modules or cartridges have been inserted into the vapor collection device, for sample collection.

10. A system as in claim 8, wherein the wafer collection module or cartridge storage compartment further comprises its own thermoelectric cooler for chilling the wafer collection modules or cartridges stored within the storage compartment.

11. A system as in claim 1, wherein each wafer collection module or cartridge comprises a thermoset, epoxy or other polymer substrate containing a bundle of capillaries.

12. A system as in claim 1, wherein each wafer collection module or cartridge further comprises a heat transfer plate for direct thermal contact with the cold plate of the thermoelectric cooler.

13. A system as in claim 1, wherein each wafer collection module or cartridge comprises an RFID identifying tag.

14. A system as in claim 13, wherein the vapor collection device further comprises an RFID reader for reading the RFID tag of an inserted module or cartridge.

15. A system as in claim 14, wherein the system is configured to record use data relative to one or more of date and time of sample collection, wafer temperature at the time of sample collection, location data for where the sample was collected, humidity at the location of sample collection, ambient temperature at the location of sample collection, or vapor sample flow rate during sample collection.

16. A system as in claim 1, wherein the module or cartridge is cooled to a temperature of no greater than 0° C. during sample collection.

17. A system as in claim 1, wherein the module or cartridge is cooled to a temperature in a range from 0° C. to −40° C. during sample collection.

18. A system as in claim 1, wherein each wafer collection module or cartridge comprises a thermistor, and the device is configured to commence flow of the vapor sample only once a predetermined threshold chilled temperature of the wafer collection module or cartridge has been reached.

19. A system as in claim 1, wherein the sample probe is heated to a temperature above an ambient temperature at the location of sample collection.

20. A system as in claim 1, wherein the device includes a door and associated clamp, for closing over and clamping the module or cartridge into a chamber of the vapor collection device during sample collection.
